(19) United States
(12) Patent Application Publication
(10) Pub. No.: US 2016/0119359 A1
(43) Pub. Date: Apr. 28, 2016

(54) SYSTEM AND METHOD FOR PROVIDING A SECURE ACCESS IN AN ORGANIZATION SYSTEM

(71) Applicant: SAMYUTAM SOFTWARE SOLUTIONS PVT. LTD, CHENNAI, IN (US)

(72) Inventors: Vijay Krishna, Chennai, IN (US); Suresh Kumar Gupta, New Delhi, IN (US)

(21) Appl. No.: 14/924,740

(22) Filed: Oct. 28, 2015

(30) Foreign Application Priority Data
Oct. 28, 2014 (IN) 5367 /CHE/2014

(51) Int. Cl. H04L 29/06; G06F 21/62; G06F 21/60

(52) U.S. Cl. CPC H04L 63/102; H04L 63/101; G06F 21/604; G06F 21/6218

(57) ABSTRACT

The present invention integrates user, application and server level security with standard operating procedures, thus providing an end to end security blanket over the organization's network and information security. The invention provides step by step directions for processing accurate transactions, which are free from deviations, transactional errors and security breaches. The invention intelligently & instantly analyzes the commands that are being fed into the organization system/application, and then decides to either accept or reject the direction given by the user versus a predefined protocol. As such, although the words are being keyed through a keyboard, the present invention intelligence interacts with the external device to understand the command or input, suggesting alterations or lets it through. The instructions provided through the mouse or the mouse pad, are also prescreened before letting the instructions getting into or out of the system.

### FIELD OF THE INVENTION

This present embodiment relates to a system and method for providing a secure access to the organization system based on a user access privilege. In particular, the embodiment relates to a system and method for analyzing each input of the user and determining whether to accept/reject the input (both data as well as navigational flow) before feeding into the applications/resources of the organization system with or without parsing or applying business logic.

### BACKGROUND OF THE INVENTION

The main challenge for the big corporate companies in the field of accounts, legal, medical, information technology and telecommunication or the BFSI industries, is to maintain a high degree of client satisfaction while keeping finances healthy. Hence, all the corporate companies are spending time and money to maintain an efficient customer relationship team. Most of the corporate companies have outsourced their back office operations to third party service providers. Outsourcing and, particularly, Business Process Outsourcing (BPO) may be understood to describe a situation where a client organization (i.e. corporate companies) imposes a specific set of tasks upon a third party. The third party may be a separate or an auxiliary organization. The third party may be located in another country or in a location near the client organization.

The third party employs number of people to perform the specified tasks for the client organization. The third party service provider spends more time and money to give specific training for the employees to achieve the specified tasks in an efficient manner with highest data integrity & following the prescribed operating standards. The employees of the third party are not connected to the client organization. If any mistake happens inadvertently in the third party system it will affect the entire business of both client organization and the third party service provider. Hence, it is mandatory to define the protocol and set of procedure for the employees to operate in the third party system. Further, it is necessary to impose certain technical restrictions (to assist in fulfilling its regulatory/compliance obligations) for the employees of the third party service provider based on the role and/or designation.

Accordingly, it is a necessity to develop the tool/system/application & methodology to provide a role based access for the third party system and also to monitor the input and output of the third party system in order to maintain the third party system to work in a defined manner and it should not deviate from the protocol and/or set of procedures.

### OBJECTS OF THE INVENTION

The principle object of the present embodiment is to provide a highly secure access to an organization system which includes a network of computers and/or a computer based on a user access privilege. The user access privilege includes a list of applications/resources, a list of functions corresponding to each of the list of applications and inputs acceptance/rejection criteria for each of the list of functions as needed per the regulation, compliance & productivity requirements of the Client & the organization.

Another object of the present embodiment is to provide a system and method for providing a secure platform to a user based on his role in an organization system (i.e. computer connected in the network). The organization system includes a organization sever which stores (i) list of users and their role, (ii) list of application/resources allocated to each of the list of users and/or their role and (iii) inputs acceptance/rejection criteria for each of the list of users. The system receives a user identity from the user and provides the secure platform based on the user identity and transmits the user identity to the organization server to retrieve the access privilege and/or role. The secure platform provides access to the list of applications/resources based on his role and/or access privilege identified in the organization server as defined by either or both the Client & the Third party organization. The instructions provided through the mouse or the mouse pad, are also prescreened before letting the instructions getting into or out of the system. Hence, any unsecure commands like printing or copying the data into another application or the external devices like the pen-drives or storage devices are flushed out. In addition to screening the inputs, this invention provides a step by step flow to each transaction along with automation snippets or process robotics to help in the flow of the process, hence increasing productivity and accuracy of transactions. The invention standardizes and secures operational transactions in banking, finance, insurance and healthcare domains.

In yet another object of the present embodiment is to provide a system and method for secure and navigational guidance with minimal workflow training on the platform to a user in an organization system. The system receives a user identity from the user and retrieves a list of tasks assigned to the user and its priority level from an organization server corresponding to the user identity. The system also retrieves the access privilege assigned to the user. The system provides the access to the list of applications/resources in the organization system based on the user's task assignment and the priority level and the access privilege along with the guidance of the step by step standard operating procedures in the work flow of application.

### BRIEF DESCRIPTION OF DRAWINGS

The foregoing summary, as well as the following detailed description of preferred embodiments, is better understood when read in conjunction with the appended drawings. For the purpose of illustrating the invention, there is shown in the drawings example constructions of the invention. However, the invention is not limited to the specific systems and methods disclosed. In the drawings:

FIG. 1 illustrates a system view of user communicating with an organization system via SAM-SECURE according to an embodiment herein;

FIG. 2 illustrates a database of an organization server in accordance to an embodiment herein;

FIG. 3 is a flow diagram which illustrates a method for accessing the organization system via the SAM-SECURE of FIG. 1 in accordance to one embodiment herein;

FIG. 4 is a flow diagram which illustrates a method of transaction flow and security control while accessing the organization system via the SAM-SECURE of FIG. 1 in accordance to one embodiment herein;

FIG. 5 is a flow diagram which illustrates a method of input and output control while accessing the organization system via the SAM-SECURE of FIG. 1 in accordance to one embodiment herein; and

FIG. 6 illustrates a SAM-SENSE of the organization system of FIG. 1 in accordance to one embodiment herein.

### DETAILED DESCRIPTION OP PREFERRED EMBODIMENTS

The present invention will be described herein below with reference to the accompanying drawings. A system and method for providing a secure access to an organization system is described.

The following description is of exemplary embodiment of the invention only, and does not limit the scope, applicability or configuration of the invention. Rather, the following description is intended to provide a convenient illustration for implementing various embodiments of the invention. As will become apparent, various changes may be made in the function and arrangement of the structural/operational features described in these embodiments without departing from the scope of the invention as set forth herein. It should be appreciated that the description herein may be adapted to be employed with alternatively configured devices having different shaped, components, and the like and still fall within the scope of the present invention. Thus the detailed description herein is presented for purposes of illustration only and not of limitation.

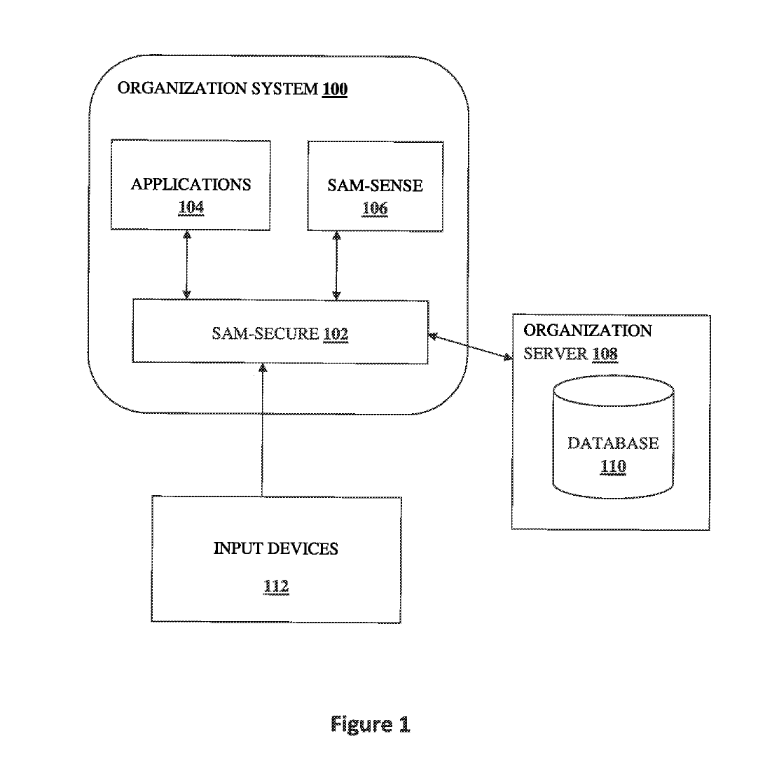

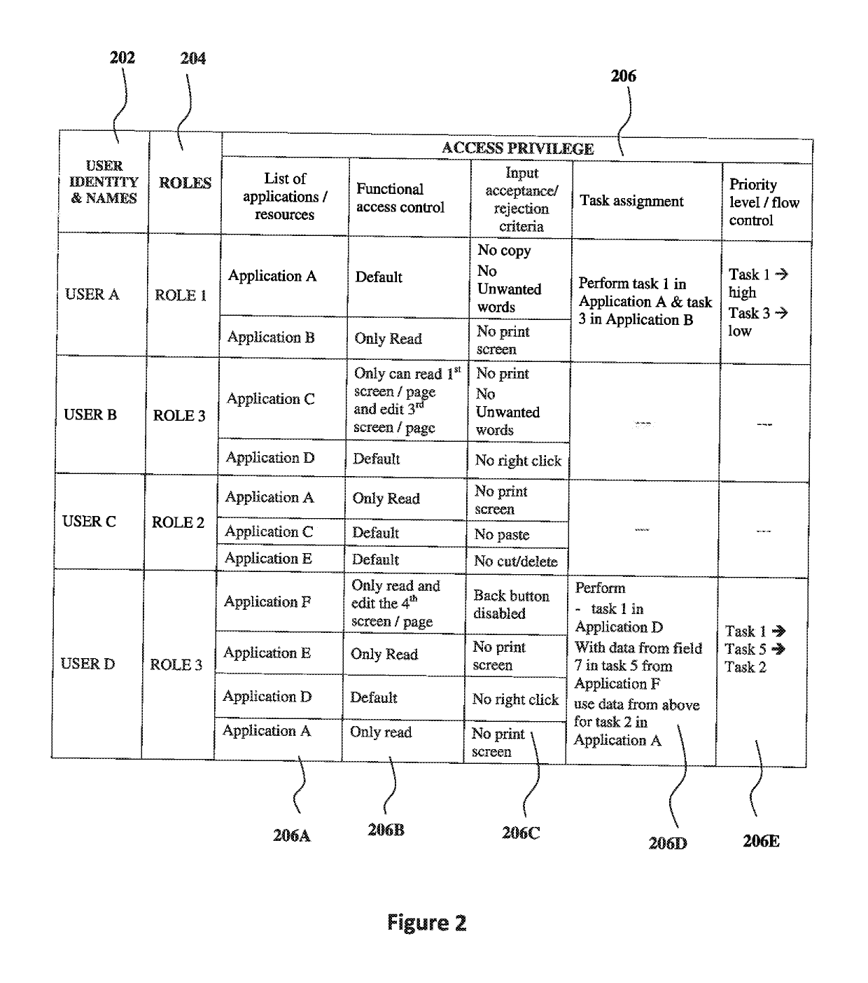

FIG. 1 illustrates a system view of user communicating with an organization system 100 via SAM-SECURE 102 in accordance to an embodiment herein. FIG. 2 illustrates a database 200 of an organization server 108 in accordance to an embodiment herein. The organization system 100 may be a Personal Digital Assistant (PDA), a personal computer (PC), a laptop and/or a network of computers etc. The SAM-SECURE 102 is an application and/or software program which is residing within the organization system 100. The organization system 100 may include one or more computer system connected to the organization server 108 through wired or wireless network. The user can access the application/resources 104 of the organization system 100 only through SAM-SECURE 102 by inputting a user identity. The SAM-SECURE 102 is acting as a security blanket for all the applications/resources 104 in the organization system 100. The organization server 108 includes the database 200 which stores access privilege corresponds to the user identity. The access privilege includes but not limited to (i) a list of users 202 and their role corresponding to the user identity 204, (ii) a list of application/resources allocated to each of the list of users and/or their role 206A & 206B, (iii) inputs acceptance/rejection criteria for each of the list of users specific to each of the applications 206C, (iv) a list task assignment 206D and (v) priority level or flow control for each of the list of task assignment 206E. In one embodiment, the organization server 108 is located remote to the organization system 100. In another embodiment, the organization server 108 is a part of the organization system 100 itself i.e. the organization server 108 resides within the organization system 100. The SAM-SECURE Console 106 also known as sensor 106 which is a Graphical User Interface of the SAM-SECURE which displays elements of the applications/resources 104 of the organization system 100. The inputs for the applications/resources 104 are received via the GUI of the sensor 106 and the output also displayed in the GUI. The SAM-SECURE 102 includes one or more modules which are not shown in the figures. The one or more modules includes but not limited to an input receiving module, an input validating module and an input feeding module. The input receiving module is configured to receive the input from SAM-SECURE Console 106. The input validating module is configured to validate the input based on the access privilege stored in the database 200. The input feeding module is configured to feed the input into the applications 104 when the input is successfully validated in the input validating module. The instructions provided through the mouse or the mouse pad, are also prescreened before letting the instructions getting into or out of the system. Hence, any unsecure commands like printing or copying the data into another application or the external devices like the pen-drives or storage devices are flushed out. In addition to screening the inputs, this invention provides a step by step flow to each transaction along with automation snippets or process robotics to help in the flow of the process, hence increasing productivity and accuracy of transactions. The invention standardizes and secures operational transactions in banking, finance, insurance and healthcare domains.

Upon receiving the user identity from the user, the SAM-SECURE 102 send the user identity to the organization server 108 for retrieving the access privilege 206 associated to the user. The SAM-SECURE 102 configures the organization system 100 based on the access privilege 206 to provide secure platform for the user to access the applications/resources 104 of the organization system 100. Access to the applications/resources 104 is configured based on the access privilege 206 listed in the column 206A & 206B and further the flow of access to the applications/resources is aligned based on the access privilege listed in the column 206D and 206E. In addition, the input to the applications/resources 104 and the output of the applications/resources 104 are controlled based on access privilege listed in the column 206C.

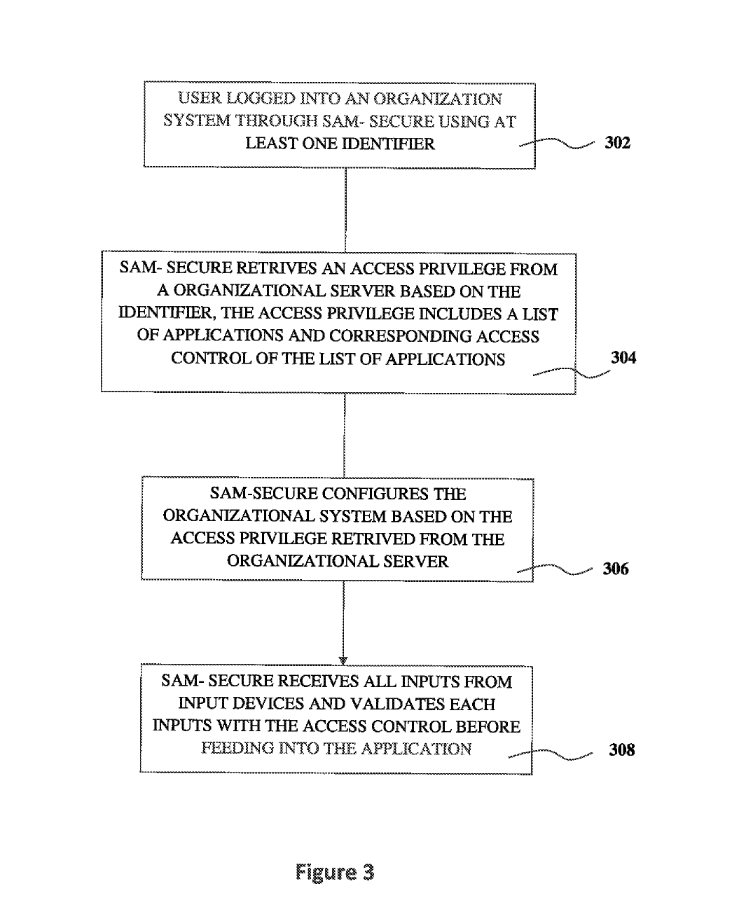

FIG. 3 is a flow diagram which illustrates a method for accessing the organization system via the SAM-SECURE 102 of FIG. 1 in accordance to one embodiment herein. In step 302, the user is logged into the organization system via the SAM-SECURE 102 by entering the user identity. For example, the user logged in through a user Login or card swipe or biometric entry. In one embodiment, the company access card is swiped (in office premises), the user's presence is generated and login is facilitated. The SAM-SECURE 102 automatically records login hours and aux timings for each user, which is housed centrally in organization servers that enables attendance and absence reports. The same card swipe and system login reports are also utilized in verifying overtime efforts. In step 304, the SAM-SECURE 102 retrieve an access privilege from a server based on the user identity. The access privilege is depicted in the FIG. 2. In step 306, the SAM-SECURE 102 configure to provide access to the organization system 100 based on the access privilege allocated the user for accessing the application/resources 104 in the organization system 100. Once a user identity is recognized in the organization server 108, the SAM-SECURE 102 identifies the associated access privilege. With this, all the authorized tools, applications, platforms and software of the organization system are made available to the users in the user system 100. All such resources which are not authorized for the user are out rightly disabled for access. The SAM-SECURE 102 also allow creation of “favorites” basis of user requirements and “default” tabs to quickly open multiple applications. The users are assigned tasks on basis of their job role. Once they have access to all requisite applications, the SAM-SECURE 102 allows beginning their activities on the basis of priorities and steps defined in the database 110 of the organization server 108. Once they commence an activity, the SAM-SECURE 102 assumes the role of the mentor, guiding users, step by step on the activities to be performed. In case users try to skip a task, the SAM-SECURE 102 will raise flags and/or force users to comply with Standard Operating Procedures (SOPs) as per compliance standards of the organization or its Clients. In step 308, all inputs via keyboard/mouse/mouse-pad are screened and evaluated by the SAM-SECURE 102 based on the access privilege associated to the user identity stored in the database 110. The users do not get direct access to the applications 104 and all inputs are facilitated by the SAM-SECURE 102. The entry has to be made inside the user console of the SAM-SECURE 102, hence increasing the security of both the client & company data. Upon evaluations, the SAM-SECURE 102 either raise a flag of inconsistency/nonconformance or allow the input to flow into the application. This cycle continues for each click a user makes in the mouse and for each hit that is made on the keyboard. If a click, entry or command is evaluated as acceptable according to the user's access privilege, the SAM-SECURE will let the information flow to the client or end application, which in turn gets synchronized with the servers. In case entry is rejected, the user is prompted to correct the entry and present for reevaluation. All unaccepted data is tracked through a separate governance report for further evaluation.

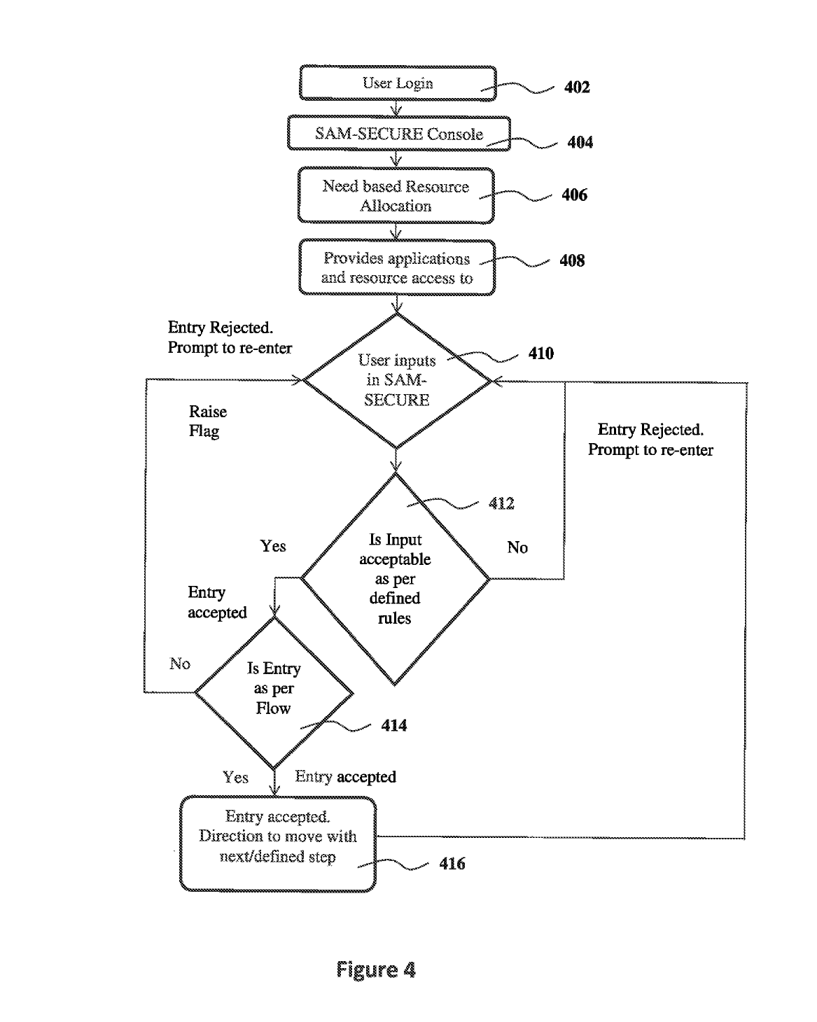

FIG. 4 is a flow diagram which illustrates a method of transaction flow and security control while accessing the organization system 100 via the SAM-SECURE 102 of FIG. 1 in accordance to one embodiment herein. Step 402: secure Login—SAM-SECURE enforces security right from step 1 i.e. users logging into the organization system 100. Secure login ensures that the users get access to the right applications and resources and the organizations information security is safe, at all times. Step 404: SAM-SECURE console—Once users enter their login credentials (i.e. user identity), they are presented with the SAM-SECURE Console 106 (known as Sensor). The Sensor assumes the role of an on-the-top Graphical User Interface (GUI) for computer as users can only view one base screen, the Sensor. Step 406: Understanding Job roles—The sensor evaluates the job role of the user, thus prepares the organization system for specific activities. All required resources/applications are optimized for use. Step 408: Resource Center—The sensor 106 houses all the user's requirements. It intelligently calculates user's software needs and optimally makes available all such applications which will be required by them during the course of their tasks. Step 410: Inputs intake—As the users gain access to all applications to begin their routine tasks, all inputs are entered through the sensor's input screen. The sensor starts the evaluation of each clicks and keyboard entry that is being made on the input screen. Step 412: Consistent evaluation—the sensor which is constantly in touch with the organization server 108 (which houses all directions and instructions i.e. access privilege), evaluates the consistency of each entry. Any entry that does not comply with the server's set of instructions is restricted and does not get processed and users are directed to re-enter or reprocess the step. If the entry is compliant, then the sensor 106 moves on to the next evaluation step. Step 414: Adherence to Standard Operating Procedures (SOPs)—Once data/information is consistent with the acceptability limits, entries are checked if they are in sequential order—users are restricted from deviations or skipping specific flow of each transaction. The system reminds users to complete essential activities before moving on to the next set. If the user has deviated from the flow, the entry is again rejected and users are directed to re-enter the inputs. If flow has been followed, the entry is accepted. Step 416: Transaction completed—Once the user has made entries which are consistent and according to the flow, SAM-SECURE sensor 106 accepts the entry and sends it to the relevant application for processing. The application is then allowed to sync with the server so that the transaction is completed. Post this, users are redirected to step 410, where they can begin their next transaction.

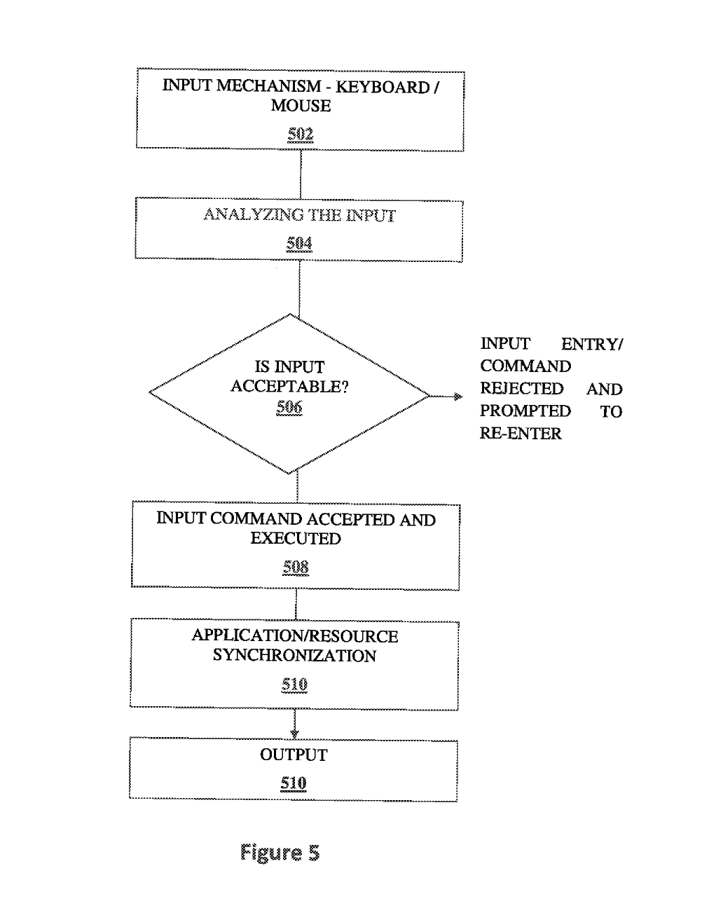

FIG. 5 is a flow diagram which illustrates a method of input and output control while accessing the organization system via the SAM-SECURE of FIG. 1 in accordance to one embodiment herein. Step 502: Input Mechanism—Users enter information to the SAM-SECURE sensor 106 either via mouse/mouse-pad or the keyboard. The Sensor 106 records and recognizes each click or typing that is executed. Users have to make inputs via the Sensor 106; the organization system 100 is restricted to receive any input apart from the sensor 106. Step 504: Analyzing the input—Once input has been entered into the sensor screen 106, it analyzes whether the input can be sent to the application 104. In doing so, it not only ensures consistency of information, but also protects the sanctity of the customer's applications. Step 506: Analyzing the command in the input—The sensor 106 analyses if the directions in the input are as per the defined work flow and is acceptable. If the input deviates from the flow or contains irrelevant/illogical information, it is rejected and a message is displayed, prompting the user to reenter the command as per appropriate flow or logic. Step 508: Command Accepted—Once the command is evaluated to be per requirement and work flow, it is flown into the application and executed. Step 510: Application/Resource synchronization—Once the command or input is executed by the sensor, it then actually flows in the application. The real time information is now housed within the application. Step 512: Output—Post application synchronization, the input is then allowed to be synced up with the client server that houses the application itself.

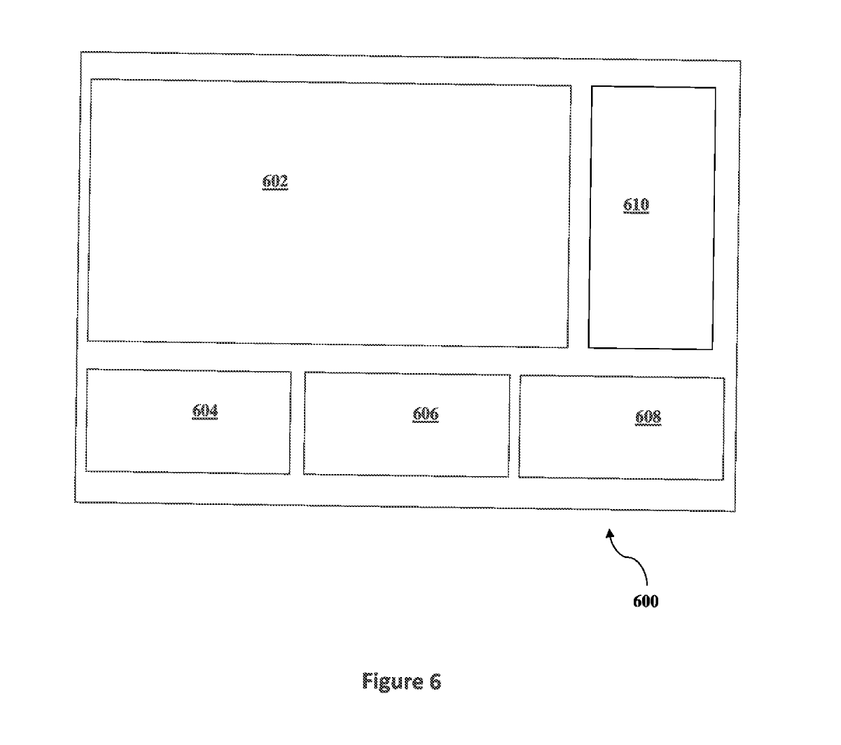

FIG. 6 illustrates the SAM-SECURE console i.e. sensor 106 of the organization system 100 of FIG. 1 in accordance to one embodiment herein. The sensor 106 is an interface which includes a live application screen 602, an input screen 604, a Shortcut Key screen 606, a Control and Resource screen 608 and a dormant Screen 610. The live application screen 602 is the area of the Sensor 106 where the current application in use is displayed. All entries being made in the input screen 604 will reflect here if the sensor 106 has allowed its flow to the live application.

The input screen 604 is the gateway to the applications/resources 104 of the organization system 100. It acts as the communication medium that carries information from users to a live application. The input screen 604 is a highly advanced tool that enables users to make data entries into the organization system 100. Once data or command is entered into the input screen 604 of the sensor 106, it evaluates the consistency of the command, basis which a decision is taken to either let it flow or to restrict its entry into the specific application i.e. upon receiving the input in the input screen 604 by the user, the SAM-SECURE 102 validates the input with the access privilege stored in the database 110 of the organization server 108. For example, the ‘user A’ is having access only to ‘Application X’ and the user is not allowed to input an unwanted, expletive or profanity words such as “fuck” or “suck” or “sex” etc. as required & suggested by the organization or its end clients. Accordingly, the live application screen display the ‘Application X’ and if the ‘user A’ enters any of the unwanted words listed above in the input screen 602, then the sensor 106 do not let the input feed into the live application of the organization system 100. In another example, the ‘user B’ is having access to ‘Application Y’ and ‘Application Z’ and the user is not allowed to use “print screen” option only when the user is accessing the ‘Application Y’. Accordingly, if the ‘user B’ is inputting the print screen option via keyboard or mouse while he was using ‘Application Y’ then the input will be not be executed in the organization system 100.

The Shortcut Key screen 606 has a unique ability to populate utilities pertaining to the current application and the current screen in use. All shortcuts or active features and the quick-fire protocols (auto-robotic actions) of the application/keyboard are populated in this section to enable faster navigation and consistent delivery of the transaction accurately. The screen 606 displays all the shortcut and control keys pertaining to the live application which is displayed in the live application screen 602. For example, when the user is accessing a browser based application then the shortcut and control keys pertaining to the application are copy, paste, back, forward, refresh, print & home etc., In one scenario, the ‘user X’ is having access to the browser based application called ‘Application A’ which includes four screens and the user X is not permitted to execute the operation of going backward when he was in the screen/page 3 out of four screen/pages in the ‘Application A’. Accordingly, if the user X pressed back button in the screen 606 when he was in the screen/page 3 then the SAM-SECURE 102 raise the flag and do not let the input feed into the organization system 100.

The Control and Resource screen 606 enables user access to various applications, tools, resources and software—basis their defined job role. It acts as a repository for all those tools that users may require during the course of their job roles as provided by the organization or its end client. Intelligently, basis user history and preferences, all favorites are automatically arranged in priority level based on the access privilege stored in the database 110. For example, the user X has access to the ‘Application 1’, ‘Application 2’ and ‘Application 3’ and out of these three applications the user have perform first task on ‘Application 3’ and second task on ‘Application 1’ and third task on ‘Application 2’. Accordingly, the screen 606 displays these favorite applications in an order viz., ‘Application 3’, ‘Application 1’ and ‘Application 2’. Further, the SAM-SECURE 102 does not allow the user X to open the ‘Application 1’ unless the user finishes his task in ‘Application 3’.

The dormant Screen 610 displays other applications which are currently not being used (but are required in the execution of a transaction) in this screen of the sensor 106. At any time, if a user has to switch applications, they need to click on the dormant screen 610 and it will become displayed in the live application screen 602, where input will now be directed. For example, the user X is currently accessing the ‘Application A’ and requires to do a calculation in the calculator application which is accessible by the user. Accordingly, the user X clicks the calculator application in the dormant screen 610 to display it in the live application screen 602.

Sam-Secure 102 does not allow live access (cannot type or click on the end client application or any other application except through Sam-Secure console; this completely protects & secures the end customer/client/organization data. Sam-Secure 102 also does not allow any files to be stored randomly in any place/folder; the user may not be able to store the files on desktop etc. (that may be lost if a system crashes); Sam-Secure lets users to store any required data or file basis the SOP & in the authorized system drives or folders. This further enhances the safety & the organization of the data along with ensuring the adherence to company/Client compliance standards.

SAM-SECURE guarantee a new outlook towards secure, standardized and streamlined business processes. A security mechanism so path-breaking, that it changes the way operations will be conducted across industries. SAM-SECURE ensure:
Zero deviations to set procedures
prevents misuse, abuse or mistakes
ensures adherence to information security policies
Protects data & delivers consistency
Confirms total system protection at the beginning-of-the-tunnel (unlike the old-fashioned end-of-tunnel security)

The SAM-SECURE is more than just a security application. The SAM-SECURE drives security right from the user login, to the application or to the server. Imagine a reinforced X-ray scanning/scrutinizing/dissecting & steel casing over:
Each transaction that is processed
Every click that is transmitted on the system
Each command or each byte of data

SAM-SECURE enforces standard operating procedures and out-rightly rejects deviations however menial they are; thus, improving throughput and accuracy levels. It addresses challenges pertaining to (i) Productivity, (ii) Quality, (iii) Consistency, (iv) Training, (v) Auditing, (vi) Feedback, (vii) Re-training, (viii) Employee behavior and (ix) Employee skill-set. With standardization of each process, organizations will reduce costs and optimize utilization of resources—both human and technology. Its advanced system control features allow users to do only what they are supposed to do; SAM-SECURE “tells” users what to do, guides and monitors the flow and the input, hence, zero deviations and 100% compliance.

The advantages of the SAM-SECURE are listed below:
1. Preventive Security: SAM-SECURE does not report security breaches—because, it does not let them happen in the first place. It is an intelligent mechanism which guarantees 100% compliance to the organizations security policies and procedures, irrespective of roles, designations and choices! Hence companies & the end client data & the systems are safe.
2. Total Security cover: SAM-SECURE places an impregnable shield across client servers, internal systems and user consoles. Unlike other technologies which secure only remote connections, SAM-SECURE implements end to end lamination over networks by residing inside the system: anything and everything that is accessed (basis defined user rights) is PRE-EVALUATED and then allowed to be actually executed. Since the data is already screened, the transaction is always conducted per protocol, hence no scope for any abuse of the system. As such, although the words are being keyed through a keyboard, our intelligence interacts with the external device to understand the command or input, suggesting alterations or lets it through. The instructions provided through the mouse or the mouse pad, are also prescreened before letting the instructions getting into the system. Hence we also flush out any unsecure commands like printing or copying the data into another application or the external devices like the pen-drives or storage devices.
3. Navigation System: Another unique feature is the Navigation Console. This front end user interface assesses the security levels of each user, in turn allowing usage of specific tools, resource or applications which are related to their job role. A set of protocol/logic is built for each application ensuring absolute security & navigational instructions. Basically, once a user logs into the system (s)he cannot deviate from the pre laid tracks of security & process adherence. The navigation console guides user activities, tracks performance and ensures total security against system misuse and security breaches.
4. Process Standard Operating Procedures—The guidance system: SAM-SECURE operates all activities inside a prebuilt framework—logic which is the baseline standard of Operating procedures. Step after step, activity after activity SAM-SECURE drives SOPs and ensure 100% deviation free transaction. User's will have to follow protocol and will be unable to skip processing steps. This guarantees accurate outcomes. In case of processing changes, update patches are fed from backend and SAM-SECURE drives these changes in processing screens. SAM-SECURE ultimately assume the role of “Source of Truth & function” for all transactions.
5. Reduced Training Efforts: SAM-SECURE assumes the role of “Source of Truth & function” since logic and processing steps along with navigation protocols, both inter and intra application, are pre-defined in the system, thus minimizing human intervention. SAM-SECURE “steers” the actions of each transaction, making users' complete essential activities step by step, without skipping any event. This implies a reduced need of user training as they are doing what SAM-SECURE is asking them to. Users simply need to follow directions given by SAM-SECURE (like choosing between options, adding comments, making specific decisions, clicks on apps, initiating calculations, verifying the populated data in forms etc. . . . ). Once initially & minimally trained on the product & system, users can immediately be deployed on real-time production environments, resulting in accurate and efficient operations
   a. Considerable reduction in overall training time and effort
   b. Considerably reduced ramp up/unproductive period
   c. Productive resources right from day 1 (in most of the processes)
   d. Reduction in Turnaround Time for transactions
   e. Reduction in need to maintain full-fledged training teams
   f. Reduction in effort required for floor support and SME staff
   g. Processing updates centrally deployed and adhered—no need for frequent team meetings, updates and reviews
   h. Need for highly experienced/trained staff is eliminated
6. Employee Motivation: SAM-SECURE provides knowledge, direction and structure to a process. Employees can now focus on decision making, speed of transactions and accuracy of outcomes rather than be involved in remembering the guidelines and operating procedures or steps while processing transactions. It lowers their anxiety and frustration, since the confidence level of accuracy is greatly enhanced by SAM-SECURE. Additionally, employees know that their activities are being monitored real time, hence, greater outcomes and higher productivity.
7. Intelligent Reporting and Monitoring: SAM-SECURE is capable of Single Click reporting—everything is being monitored (except the client related sensitive information, as suggested by both End client & the current organization) and recorded and Real time dashboards of employee & the process health are populated, by each click of the mouse/keystroke. Be it man hours utilization or Aux time management, individual productivity or team performance; SAM-SECURE generates reports for various levels of management, all at the click of a button. Reporting requirements can be Dynamic—so your SAM-SECURE has integrated flexible reporting mechanism; whatever the format, SAM-SECURE chums it out, again, with a single click.

The embodiments herein can take the form of an entirely hardware embodiment, an entirely software embodiment or an embodiment including both hardware and software elements. The embodiments that are implemented in software include but are not limited to, firmware, resident software, microcode, etc.

Furthermore, the embodiments herein can take the form of a computer program product accessible from a computer-usable or computer-readable medium providing program code for use by or in connection with a computer or any instruction execution system, for the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

Several exemplary embodiments have thus been described. Modifications and alterations may occur to others upon reading and understanding the preceding detailed description. It is intended that the exemplary embodiments be construed as including all such modifications and alterations insofar as they come within the scope of the appended claims or the equivalents thereof.

We claim:

1. A method for providing a secure access to an organization system comprising the steps of:
receiving an user identity from an user;
retrieving, from a database of an organization server, an access privilege associated with said user identity;
configuring an interface based on said access privilege;
receiving, by an input device, an input in said interface;
determining whether said input is acceptable based on said access privilege;
accepting said input for an organization system if it is allowed in said access privilege; and
rejecting said input if it is not allowed in said access privilege.

2. The method of claim 1, wherein said access privilege comprises (i) a list of applications, (ii) an input acceptance/rejection criteria, (iii) a task assignment and (iv) a flow control.

3. The method of claim 2, wherein said interface comprises (i) an input screen for receiving said input from said input device, (ii) a live application screen which display a live application which is currently being executed in an user system, (iii) a Control and Resource screen which display a list of applications where said user permitted to access based on said task assignment and said flow control defined in said access privilege, (iv) a Shortcut Key screen which display a list of shortcut keys associated to said live application currently being running in said live application screen and (v) a dormant Screen which displays a plurality of applications required to execute to said live application.

4. The method of claim 3, wherein said live application is determined from said list of applications based on said flow control.

5. The method of claim 3, wherein said input received from said input screen as well as from said shortcut screen is analyzed based on said flow control and/or input acceptance/rejection criteria defined in said access privilege before feeding into said live application.

6. The method of claim 3, wherein said input received from said Control and Resource screen is analyzed based on said flow control defined in said access privilege before feeding into said live application screen.

7. The method of claim 1, wherein said input device is a keyboard, a mouse or a joystick.

8. A method for providing a secure access to an organization system comprising the steps of:
receiving an user identity from an user;
retrieving, from a database of an organization server, an access privilege associated with said user identity, wherein said access privilege comprises (i) a list of applications, (ii) an input acceptance/rejection criteria, (iii) a task assignment and (iv) a flow control;
configuring an interface based on said access privilege, wherein said interface comprises an input screen, a live application screen and at least one of a Control and Resource screen, a Shortcut Key screen and a dormant Screen;
displaying a live application in said live application screen based on said flow control defined in said access privilege;
receiving, by an input device, an input in said input screen;
validating said input based on input acceptance/rejection criteria defined in said access privilege, wherein said input is validated to check whether said input is acceptable to said live application based on said access privilege;
feeding said input to said live application upon said input is validated successfully;
rejecting said input and raising a flag when validation of said input is un successful.

9. The method of claim 8, wherein said Shortcut Key screen displays a plurality of button associated to said live application running on said live application.

10. The method of claim 9, wherein said plurality of buttons comprises at least one of a copy, a paste, a back, a refresh and a forward, wherein said input received from said input screen as well as from said shortcut screen is analyzed based on said flow control and/or input acceptance/rejection criteria defined in said access privilege before feeding into said live application.

11. The method of claim 8, wherein said Control and Resource screen displays applications which allocated to said user identity and other than said live application, wherein said applications are arranged based on said flow control, wherein said input received in said Control and Resource screen is validated based on said flow control.

12. The method of claim 8, wherein said dormant Screen displays applications which are required to complete said live application.

13. The system for providing a secure access to an organization system comprising:
an organization server that comprising a database which stores a plurality of user identity and an access privilege associated to each of said plurality of user identity;
an user system which is in communication with said organization server, wherein said user system configured to
receive an user identity from an user;
retrieve, from said database, said access privilege associated with said user identity;
provide an interface in said user system based on said access privilege;
receive, by an input device, an input in said interface;
determine whether said input is acceptable based on said access privilege;
accept said input if it is allowed in said access privilege; and
reject said input if it is not allowed in said access privilege.

14. The system of claim 13, wherein said input device is a keyboard, a mouse or a joystick.
